(19) United States
(12) Patent Application Publication
(10) Pub. No.: US 2024/0211796 A1
(43) Pub. Date: Jun. 27, 2024

(54) EXPLANATION OF EMERGENT SEMANTICS IN EMBEDDING SPACES VIA ANALOGY

(71) Applicant: Microsoft Technology Licensing, LLC, Redmond, WA (US)

(72) Inventors: Maurice DIESENDRUCK, Bellevue, WA (US); Leo Moreno BETTHAUSER, Kirkland, WA (US); Urszula Stefania CHAJEWSKA, Camano Island, WA (US); Rohith Venkata PESALA, Redmond, WA (US); Robin ABRAHAM, Redmond, WA (US)

(21) Appl. No.: 18/087,470

(22) Filed: Dec. 22, 2022

(51) Int. Cl. G06N 20/00; G06F 18/2113; G06F 18/2137

(52) U.S. Cl. CPC G06N 20/00; G06F 18/2113; G06F 18/21375

(57) ABSTRACT

The present disclosure relates to utilizing an embedding space relationship query exploration system to explore embedding spaces generated by machine-learning models. For example, the embedding space relationship query exploration system facilitates efficiently and flexibly revealing relationships that are encoded in a machine-learning model during training and inferencing. In particular, the embedding space relationship query exploration system utilizes various embeddings relationship query models to explore and discover the relationship types being learned and preserved within the embedding space of a machine-learning model.

### BACKGROUND

Recent years have seen significant advancements in both hardware and software with respect to creating, utilizing, and improving machine-learning models. For example, the hardware on most modern computing devices, including portable devices, is capable of implementing various machine-learning models including neural networks. Comparably, improvements in software have enabled a wide variety of machine-learning model types that improve data processing and predictions.

Along with the rise in popularity in using machine-learning models, there has come an increased need for greater transparency and understanding regarding how machine-learning models arrive at their predictive decisions. For example, many conventional systems use machine-learning models that resemble a “black box,” where inputs automatically turn into outputs without any evidence of how the transformation occurred. Indeed, most of these conventional systems cannot provide information regarding the logic and significance of what relationships played a role in the automated decision-making process. Further, while some conventional systems have attempted to provide greater transparency, these conventional systems suffer from problems in relation to various technical problems.

These, along with additional problems and issues, exist in conventional systems with respect to indicating how and why machine-learning models operate to reach their results.

### BRIEF DESCRIPTION OF THE DRAWINGS

The detailed description provides one or more implementations with additional specificity and detail through the use of the accompanying drawings, as briefly described below.

FIG. 1 illustrates an example overview for exploring embedding space relationships of a machine-learning model utilizing embeddings relationship query models in accordance with one or more implementations.

FIG. 2 illustrates an example diagram of a computing device where an embeddings relationship system (i.e., an embedding space relationship query exploration system) is implemented in accordance with one or more implementations.

FIG. 3 illustrates an example operational diagram of an object pair analogy embeddings relationship query model in accordance with one or more implementations.

FIG. 4 illustrates an example operational diagram of an object similarity embeddings relationship query model in accordance with one or more implementations.

FIG. 5 illustrates an example operational diagram of an embeddings relationship preservation query model in accordance with one or more implementations.

FIG. 6 illustrates an example operational diagram of an emergent semantics embeddings relationship query model in accordance with one or more implementations.

FIG. 7 illustrates an example series of acts for utilizing a machine-learning model to determine the relationship of embeddings for the machine-learning model in accordance with one or more implementations.

FIG. 8 illustrates certain components that may be included within a computer system.

### DETAILED DESCRIPTION

This document describes utilizing an embedding space relationship query exploration system (an “embeddings relationship system” for short) to explore embedding spaces generated by machine-learning models. For example, the embeddings relationship system facilitates efficiently and flexibly revealing relationships that are encoded in a machine-learning model during training and inferencing. In particular, the embeddings relationship system utilizes various embeddings relationship query models to explore the types of relationships that are being preserved within the embedding space of a machine-learning model.

Indeed, implementations of the present disclosure solve one or more of the problems mentioned above as well as other problems in the art with systems, computer-readable media, and methods by utilizing the embeddings relationship system to dynamically reveal several applications and advantages, such as which relationship features from input data are being encoded into the embedding space of a wide range of machine-learning models, the strength of various encoded relationship, and whether encoded relationships strengthen or weaken with model updates.

To illustrate, the embedding space relationship query exploration system (e.g., the “embeddings relationship system”) can facilitate revealing embedding relationships within a machine-learning model. Accordingly, in one or more implementations, the embeddings relationship system provides one or more input objects to the machine-learning model, which includes generating a first encoded point in an embedding space by encoding a first object utilizing the machine-learning model, wherein the embedding space includes encoded points based on a set of input data. In addition, when a second input object is provided as part of an input object, the embeddings relationship system also generates a second encoded point in the embedding space by encoding a second object utilizing the machine-learning model.

Continuing from the above paragraph, in these implementations, the embeddings relationship system determines, within the embedding space, a pairwise embedding relationship between the first encoded point and the second encoded point as well as generates a set of output object pairs by identifying pairs of objects that correspond to pairs of encoded points within the embedding space having the pairwise embedding relationship. Further, the embeddings relationship system provides the set of output object pairs, such as to a client device.

In various implementations, the embeddings relationship system utilizes one or more embeddings relationship query models to explore relationships within the embedding space of a machine-learning model. Examples of embeddings relationship query models include an object pair analogy model, an object similarity model, a relationship preservation model, and an emergent semantics model. These types of embeddings relationship query modes are described below in greater detail.

As described herein, the embeddings relationship system provides several technical benefits with respect to embedding space exploration of a machine-learning model. Indeed, the embeddings relationship system provides several practical applications that deliver benefits and/or solve problems by providing systems and methods for describing the operations that occur in the embedding space of a machine-learning model based on revealing which embedding relationships are encoded and/or preserved. Some of these technical benefits and practical applications are discussed next as well as throughout this document.

As noted above, existing computer systems lack the ability to provide transparency regarding how a machine-learning model generates its outcomes. Some conventional systems have attempted to provide greater transparency by reducing the complexity of machine-learning models. However, by reducing model complexity, these models suffer from lower prediction accuracies. In other instances, conventional systems are ill-suited to handle various data types and must crudely convert input features to overly simplified numeric values, which also leads to inaccurate model results. Overall, many conventional systems fail to provide model transparency without sacrificing model accuracy.

As another issue, many conventional systems lack flexibility and are model type specific. For example, while these conventional systems provide transparency for a single machine-learning model or model type, they cannot be generalized to other models and/or model types. Indeed, many conventional systems have trouble abstracting away from a specific type of machine-learning model. Similarly, some conventional systems can provide limited feature contributions for numerical features but cannot provide feature contributions for other feature types.

Furthermore, conventional systems are inefficient and unable to scale to meet increasing demand. For instance, while some conventional systems are designed to handle certain features, these approaches are computationally expensive as they require significant operations (e.g., O(N²) operations), where N represents the number of encoded points in an embedding space. This exponential growth approach is often computationally infeasible.

In contrast, the embeddings relationship system performs a number of actions to both overcome and improve upon these problems. To elaborate, the embeddings relationship system provides and utilizes embeddings relationship query models to better understand the inter-workings on a machine-learning model through embedding space exploration. For example, by providing its own object inputs (e.g., raw object data as analogy pairs) to a machine-learning model, the embeddings relationship system is model-agnostic and flexibly operates across a wide range of machine-learning model types. Indeed, rather than focusing on end-of-model outputs, which significantly limits the flexibility of an evaluation model, the embeddings relationship system focuses on the embedding space, which is produced mid-model and common to most machine-learning models.

As another example, by focusing on the embedding space, the embeddings relationship system does not need to perturb the input or provide a specific type of input data. Rather, the embeddings relationship system flexibly provides any input that includes a relationship type to understand whether the relationship type or other relationship types are preserved in the embedding space of the machine-learning model. Additionally, by focusing on the embedding space, the embeddings relationship system significantly constrains the problem of identifying operations being performed by the machine-learning model, which decreases complexity and increases efficiency in understanding model operations.

As an additional example, by focusing on the embedding space, the embeddings relationship system signals what embedding relationships are being encoded in a machine-learning model, properties of the embedding space, why the machine-learning model is not working as expected, and/or where embeddings are falling short. Further, by utilizing an emergent semantics query, the embeddings relationship system provides an unbiased way of mathematically evaluating output results (e.g., understanding which relationships are preserved helps explain incorrect outputs), which improves technical accuracy and efficiency.

Additionally, the embeddings relationship system provides clearer results by not relying on arbitrary comparisons. In this manner, the embeddings relationship system produces outputs with O(N) operations, as opposed to the O(N²) operations of some existing systems. In many instances, the embeddings relationship system achieves these efficiency gains by operating in lower-dimensional spaces than input spaces, which reduces complexities and noises generated by the model.

As illustrated in the foregoing discussion, this document utilizes a variety of terms to describe the features and advantages of one or more implementations described herein. These terms are defined below as well as used throughout the document in different examples and contexts.

To illustrate, as an example of a term used in this document, the term “object” refers to data input or output from a machine-learning model. For instance, a machine-learning model trains and performs inferences based on input objects and, in some cases, provides one or more output objects. Additionally, in many implementations, the embeddings relationship system provides input object pairs to a machine-learning model to determine if one or more input object relationships (e.g., a meaningful correlation between attributes, characteristics, or features of two objects in an input object pair) are preserved in the embedding space of the machine-learning model. The embeddings relationship system, in many instances, causes the machine-learning model to generate and output one or more output object pairs. Other examples of objects described below include anchor object pairs and non-anchor object pairs.

In this document, as an example, the term “machine-learning model” refers to a computer representation that can be tuned (e.g., trained) based on inputs to approximate unknown functions. In particular, the term “machine-learning model” includes a model that utilizes algorithms to learn from, and make predictions on, known data by analyzing the known data to learn to generate outputs that reflect patterns and attributes of the known data. In many instances, a machine-learning model makes high-level abstractions in data by generating data-driven predictions or decisions from the known input data. For example, a machine-learning model includes any machine-learning model that produces embeddings and/or embedding representations.

In various implementations, a machine-learning model generates an embedding space. In this document, the term “embedding space” refers to a vectorized space where inputs are represented by multidimensional vectors, which facilitates understanding the topology of the input data. In various instances, a machine-learning model utilizes deterministic operations or transformations to convert or encode input objects into a corresponding embedding space. In many instances, embedding spaces have a reduced dimensionality lower than that of the input space (e.g., lower-dimensional representations of high-dimensional input data). Additionally, an embedding space includes embeddings (i.e., encoded points in an embedding space). Further, an embedding space is often accessible to external systems, such as the embeddings relationship system.

As mentioned, embedding spaces include embeddings. In this document, as an example, the terms “embeddings” or “encoded points” are used interchangeably and refer to a vector representation of input data mapped into an embedding space. In many instances, an embedding refers to how lower-dimensional data (e.g., lower-dimensional vectors) is mapped to the original higher-dimensional input space (e.g., high-dimensional vectors). Additionally, machine-learning models commonly create an embedding space and automatically learn and/or determine how to generate embeddings for input data to represent various features of the input data.

Also, in this document, as an example, the term “pairwise embedding relationship” refers to a meaningful semantic relationship between two objects, which is expressed by their encoded points within an embedding space. For instance, if two objects share a meaningful relationship, then the two corresponding embeddings may share a pairwise embedding relationship, as further described below. Often, embedding features are determined based on one or more embedding metrics, such as an embedding relationship metric. Embedding metrics measure the strength, magnitude, and/or extent of embedding features between one or more embeddings.

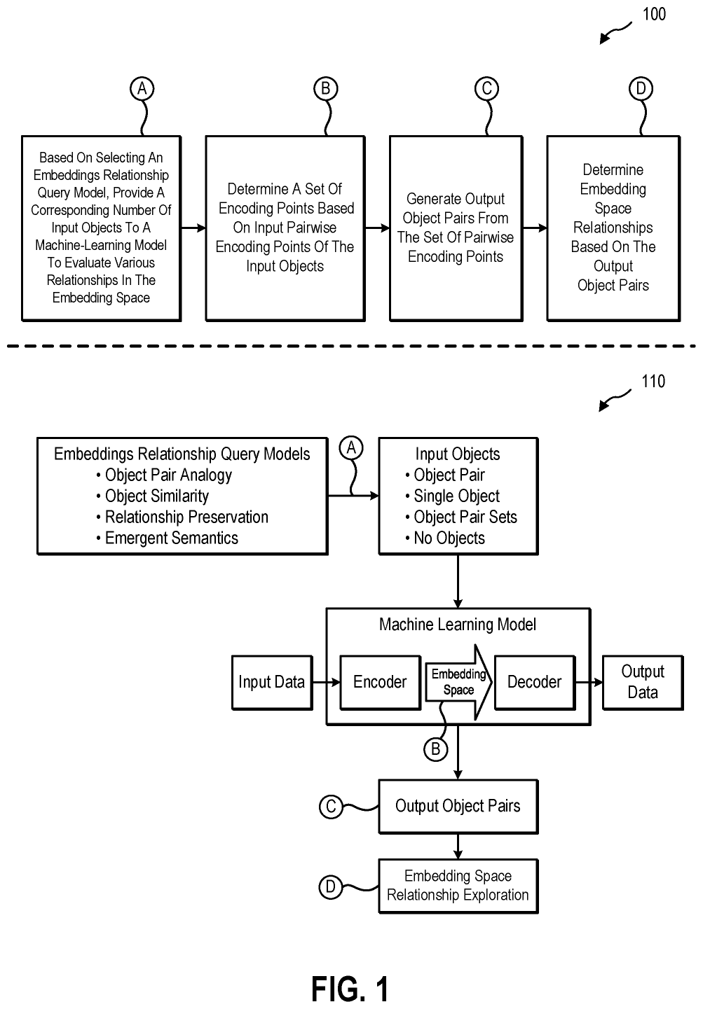

Additional details will now be provided regarding the embeddings relationship system. For example, FIG. 1 illustrates an example overview for exploring embedding space relationships in a machine-learning model utilizing embeddings relationship query models in accordance with one or more implementations. In particular, the top portion of FIG. 1 includes a series of acts 100 for utilizing the embeddings relationship system to determine embedding space relationships within a machine-learning model utilizing one or more embeddings relationship query models, and the bottom portion of FIG. 1 includes a block diagram 110 of implementing the series of acts 100 on the machine-learning model.

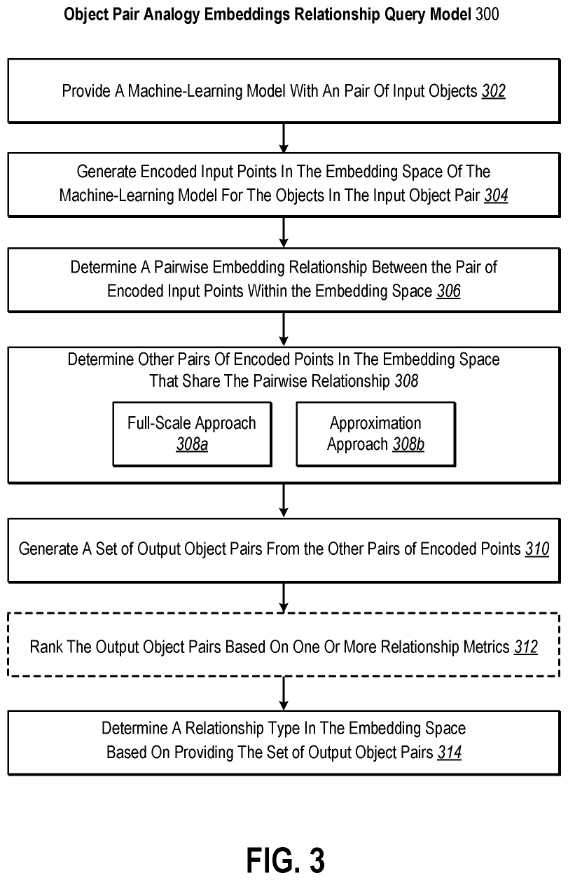

As shown in FIG. 1, the series of acts 100 includes a first act, Act A, of providing, based on selecting an embeddings relationship query model, a corresponding number of input objects to a machine learning model to evaluate various relationships in the embedded space. For example, the embeddings relationship system provides multiple embeddings relationship query models for use in connection with better understanding the workings of a given machine-learning model. For instance, as shown in FIG. 1, the embeddings relationship system facilitates various embeddings relationship query models, such as an object pair analogy, object similarity, relationship preservation, and emergent semantics. Each of these embeddings relationship query models is discussed below in turn with respect to FIGS. 3-6.

In some implementations, the embeddings relationship system detects the selection of one or more of the embeddings relationship query models. Additionally, with an embeddings relationship query model selected, the embeddings relationship system identifies, receives, or otherwise obtains a corresponding number of inputs. Depending on the embeddings relationship query model being used, the embeddings relationship system utilizes a single object pair (e.g., two objects that have one or more relationships), a single object, a set of object pairs, or no objects. As mentioned above, examples of which embeddings relationship query models correspond to which number of inputs are described below in connection with FIGS. 3-6.

As shown in the block diagram 110, input objects are provided to the machine-learning model. For example, as part of Act A, the embeddings relationship system provides the input objects to the machine-learning model. As illustrated, the machine-learning model includes an encoder that generates an embedding space from input data and a decoder that decodes encoded points in the embedding space to generate output data. While one type of machine-learning model is shown, any type of machine-learning model that generates an embedding space is possible.

As also illustrated, the inputs and outputs to the machine-learning model with respect to the embeddings relationship system differ from the general inputs and outputs of the machine-learning model. In various implementations, while the inputs and outputs may be similar or overlap, the input data utilized to train and inference the machine-learning model is separate from the input objects provided by the embeddings relationship system to the machine-learning model. In other words, the embeddings relationship system allows for querying the model with example data from arbitrary sources, including data not related to the training and testing data of the model (as long as inputs are processable by the model). In this manner, the embeddings relationship system is agnostic to the type of machine-learning model being explored, allowing the embeddings relationship system to operate across a wide-range of machine-learning models.

As shown in FIG. 1, the series of acts 100 includes a second act, Act B, of determining a set of pairwise encoding points based on input encoding points of the input objects. To elaborate, the embeddings relationship system provides the input objects to the machine-learning model, which generates corresponding encoded points in the embedding space. Based on the input encoding points of the input objects, in some instances, the embeddings relationship system determines additional pairwise encoding points in the embedding space. In addition, the embeddings relationship system may generate sets of pairwise encoding points from the embedding space based on one or more of the input encoding points (or the absence of any points depending on the embeddings relationship query model being used).

To briefly illustrate, suppose the embeddings relationship system provides an input object pair, which the machine-learning model encodes as two pairwise encoded points. In some instances, the embeddings relationship system determines a relationship type between the input pairwise encoded points based on distance, angle, path relationship, location, relative position, and/or another metric. The embeddings relationship system then identifies other encoded points that, when part of a pair, share a similar relationship type. In various instances, the embeddings relationship system identifies and groups multiple additional pairs of encoded points in the embedding space that share the relationship type of the input pairwise points.

In various implementations, embedding spaces are commonly lower-dimensional spaces than input spaces. This means that some of the noise (and sometimes complexity) of input spaces will not be preserved within the embedding space. However, the majority of important relationships that are present in the input spaces are maintained in the embedding space despite the loss of granularity. On the other hand, by operating in a lower-dimensional space, the embeddings relationship system 202 requires fewer processing resources than existing computer systems.

As shown in FIG. 1, the series of acts 100 includes a third act, Act C, of generating output object pairs from the set of pairwise encoding points. In various implementations, the embeddings relationship system maps encoded points to their corresponding objects. For example, for each identified pair of encoded points (or pairwise encoding points) in the embedding space, the embeddings relationship system generates a corresponding object pair, which is included in a set of output objects.

Additionally, as shown in FIG. 1, the series of acts 100 includes a fourth act, Act D, of exploring or determining embedding space relationships based on the output object pairs. For example, the set of output object pairs reveals the embedding relationship included in the embedding space. Depending on the embeddings relationship query model, the type of relationship may differ. In various implementations, the embeddings relationship system provides input objects to the machine-learning model without a particular relationship in mind to explore what types of relationships the embedding space is encoded. In alternative implementations, the embeddings relationship system provides sets of input object pairs to the machine-learning model all having the same relationship type to validate if the relationship type is maintained within the embedding space. These and other examples are further described below.

In various implementations, the embeddings relationship system provides indications regarding relationships within the embedding space of the machine-learning model. In some implementations, the embeddings relationship system provides the output object pairs to a user, who makes determinations regarding the embedding space and relationship types. In any case, the embeddings relationship system efficiently and flexibly facilitates identifying, exploring, and uncovering how the machine-learning model encodes and preserves relationships of input objects in its embedding space.

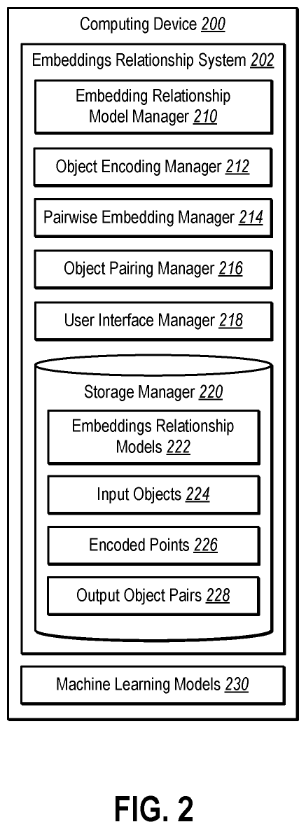

Turning to the next figure, FIG. 2 provides additional details regarding architecture of the embeddings relationship system. In particular, FIG. 2 illustrates an example diagram of a computing device 200 where an embeddings relationship system 202 (i.e., an embedding space relationship query exploration system) is implemented in accordance with one or more implementations. In particular, FIG. 2 introduces example components and elements that help better explain the functions, operations, and actions of the embeddings relationship system 202.

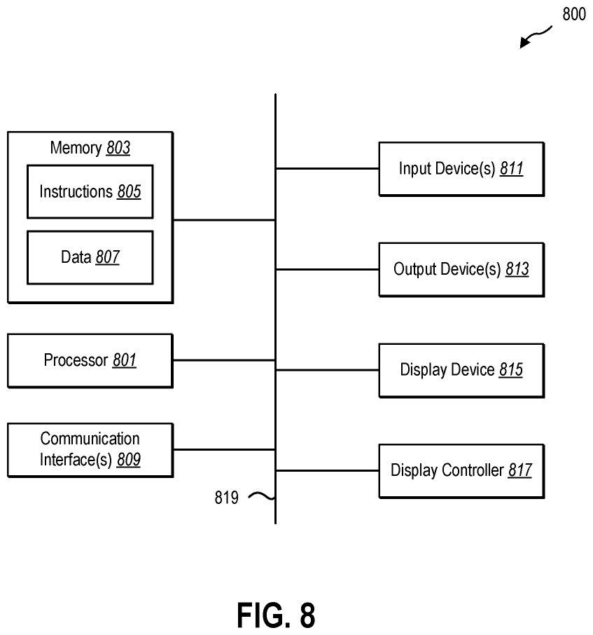

As illustrated, FIG. 2 includes a computing device 200. In general, the computing device 200 may represent various types of computing devices. For example, in some embodiments, the computing device 200 is a non-mobile computing device, such as a server, cluster of servers, desktop, or another type of non-mobile computing device. In one or more embodiments, the computing device 200 is a mobile computing device, such as a laptop, a tablet, a mobile telephone, a smartphone, etc. For example, the computing device 200 is a client device associated with a user. Additional details with regard to the computing device 200 are discussed below with respect to FIG. 8.

As shown, the computing device 200 includes the embeddings relationship system 202 and machine-learning models 230. As mentioned above, the machine-learning models 230 may include any type of machine-learning model that generates and/or provides access to an embedding space. For example, the machine-learning model is a convolutional neural network or another type of machine-learning model that encodes input data into vectors within a vector space (i.e., embedding space).

As mentioned, the embeddings relationship system 202 performs various functions with respect to exploring embedding spaces generated by machine-learning models. As shown, the embeddings relationship system 202 includes various components and elements. For example, the embeddings relationship system 202 includes an embeddings relationship model manager 210, an object encoding manager 212, a pairwise embedding manager 214, an object pairing manager 216, a user interface manager 218, and a storage manager 220. As also shown, the storage manager 220 includes embeddings relationship models 222, input objects 224, encoded points 226, and output object pairs 228.

In various implementations, the components and elements of the embeddings relationship system 202 facilitate the actions described in this document with respect to the embeddings relationship system 202. As non-limiting examples, the embeddings relationship model manager 210 manages embeddings relationship models 222, such as various embeddings relationship query models described in this document. For example, the embeddings relationship models 222 facilitates the presentation and selection (in connection with the user interface manager 218) of one or more of the embeddings relationship models 222.

As another example, in various instances, the object encoding manager 212 manages the generation of encoded points 226 from input objects 224. For example, the object encoding manager 212 causes a machine-learning model of the machine-learning models 230 to generate an encoded point for each input object. Additionally, in some implementations, the pairwise embedding manager 214 manages the encoded points 226. For example, the pairwise embedding manager 214 evaluates the encoded points 226 generated from the input objects 224 and/or encoded points 226 within the embedding space of the machine-learning model. In particular instances, the pairwise embedding manager 214 determines encoded point pairs (e.g., pairwise embedding relationships) between encoded points in the embedding space of the machine-learning model.

Additionally, in one or more implementations, the object pairing manager 216 manages the output object pairs 228. For example, the object pairing manager 216 generates sets of output object pairs 228 from the identified encoded point pairs. Further, in various implementations, the user interface manager 218 provides an interface between users and the embeddings relationship system 202. For instance, the user interface manager 218 facilitates one or more user interfaces (e.g., graphical, text, and/or interactive) for selecting embeddings relationship models 222 (mentioned above), receiving the input objects 224, and/or providing the output object pairs 228.

Although FIG. 2 illustrates an arrangement of components within the computing device 200, various additional device and/or environment configurations and arrangements are possible. For example, the computing device 200 includes additional devices for implementing some or all of the embeddings relationship system 202. Additionally, one or more of the machine-learning models 230 may be located on a different computing device.

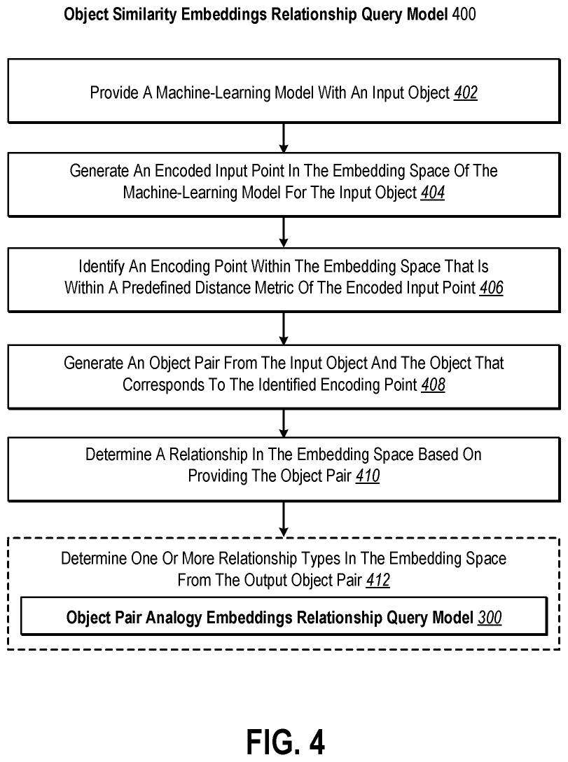

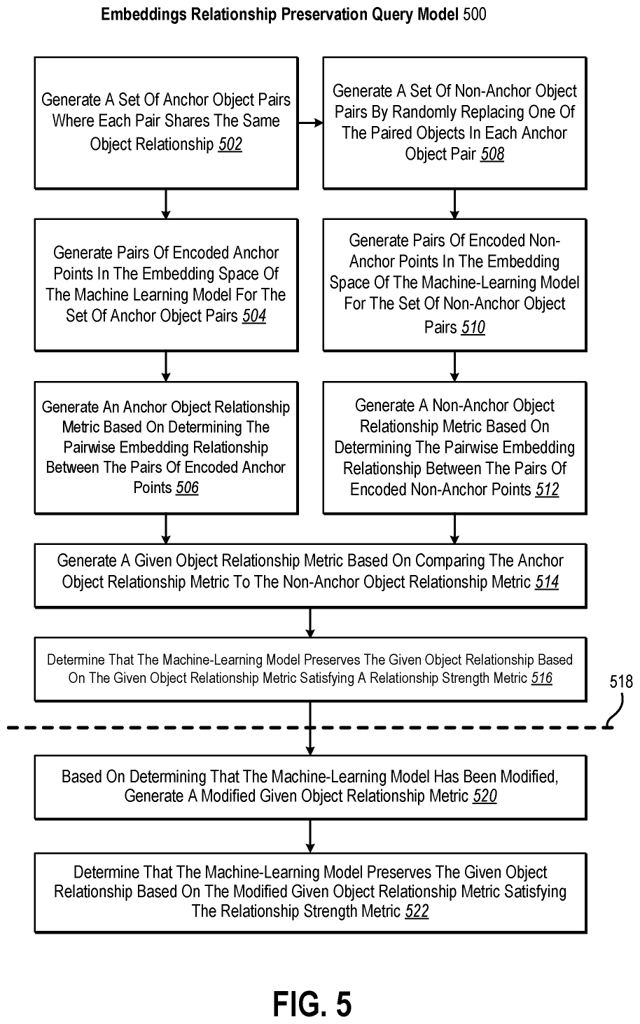

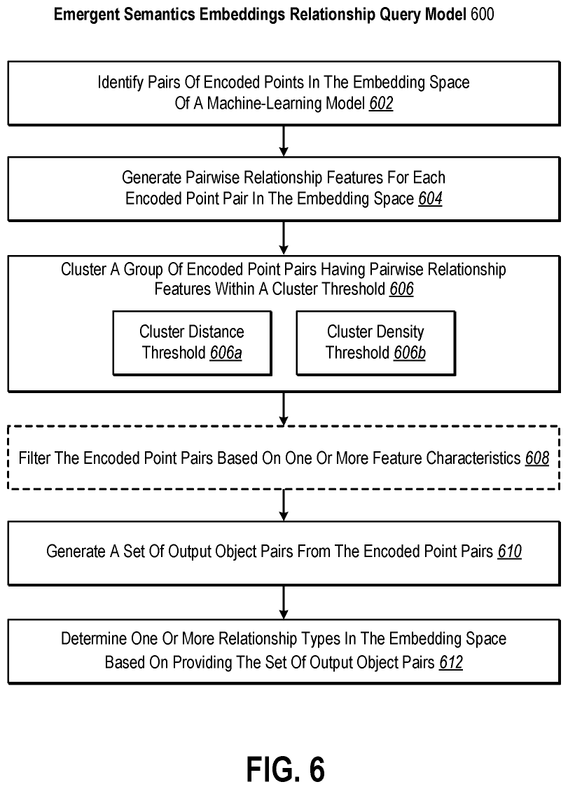

As mentioned above, FIGS. 3-6 provide additional details of the embeddings relationship system 202 with respect to implementing various embeddings relationship query models. In particular, FIG. 3 corresponds to an object pair analogy embeddings relationship query model, FIG. 4 corresponds to an object similarity embeddings relationship query model, FIG. 5 corresponds to an embeddings relationship preservation query model, and FIG. 6 corresponds to an emergent semantics embeddings relationship query model.

To illustrate, FIG. 3 shows an example operational diagram of an object pair analogy embeddings relationship query model 300 (or “object pair analogy model 300” for short) in accordance with one or more implementations. As shown, FIG. 3 includes various acts corresponding to the object pair analogy model 300 for determining relationship types in the embedding space of a machine-learning model. Each of the acts is described in turn below after additional context is first given about the object pair analogy model 300.

In various implementations, the embeddings relationship system 202 utilizes the object pair analogy model 300 to explore the embedding space of machine-learning models via analogy. For example, the embeddings relationship system 202 starts with an object pair that includes an interesting and/or representative object relationship (e.g., an explicit or implicit relationship). The embeddings relationship system 202 then utilizes the object pair analogy model 300 to determine if the machine-learning model observes, encodes, and/or preserves the given relationship by exploring the model's embedding space. In addition, the embeddings relationship system 202 determines how the machine-learning model interprets the given relationship and/or what relationships are inferable for output object pairs. Further, the embeddings relationship system 202 determines whether the machine-learning model generates an expected embedding space or a potentially deficient one (e.g., the machine-learning model fails to properly encode the given relationship).

To elaborate, the object pair analogy model 300 utilizes analogies as a creative structure for asking calibrated questions (e.g., queries) and receiving responses about the type of information and relationships a machine-learning model has learned. Accordingly, given a pair of inputs that represents a known relationship or relationship type, even one that is difficult to describe, the embeddings relationship system 202 is able to utilize the object pair analogy model 300 to recognize when output object pairs exemplify the relationship. In this manner, the embeddings relationship system 202 can provide a diverse set of input object pairs to the machine-learning model to discover what the machine-learning model has learned, what relationships the model deems important, and what is occurring in the embedding space.

To further elaborate, through the object pair analogy model 300, the embeddings relationship system 202 enables the understanding of whether a given relationship is encoded by a machine-learning model by retrieving the best-matching pairs from an input dataset, as a function of the embeddings in the model's learned embedding space. For example, in generating output object pairs, the embeddings relationship system 202 may signal whether 1) the output object pairs exemplify the same relationship as an input object pair, which indicates the model's ability to encode that type of relationship information, or 2) the output object pairs do not share the same relationship, which indicates that the model does not encode that type of relationship information.

To provide an example, the embeddings relationship system 202 identifies a machine-learning model that encodes features based on several characteristics, attributes, and information regarding each of the U.S. States (e.g., the 50 States). Accordingly, the embeddings relationship system 202 identifies the input object pair of (California, Nevada). In response to a first query, the embeddings relationship system 202 utilizes the object pair analogy model 300 to receive the first output object pairs of (Nevada, Arkansas), (Texas, Florida), and (Washington, Michigan). In this example, the embeddings relationship system 202 may reveal that the machine-learning model learns and preserves cardinality between inputs. In response to a second query, the object pair analogy model 300 provides the output object pairs of (Texas, Rhode Island), (Maine, New Jersey), and (Virginia, West Virginia). In this example, the embeddings relationship system 202 may uncover that the model learns and preserves state sizes where the first input state is larger than the second. In each case, the results provided by the embeddings relationship system 202 reveal and uncover information about the machine-learning model, and the embedding space in particular.

To illustrate, FIG. 3 shows that the object pair analogy model 300 includes an act 302 of providing a machine-learning model with a pair of input objects. In various implementations, the embeddings relationship system 202 receives, identifies, detects, or otherwise obtains an input object pair of two objects (e.g., a first or head object, and a second or tail object). For example, the embeddings relationship system 202 receives a pair of inputs provided by a user associated with a client device. In some implementations, the embeddings relationship system 202 receives the object pair from a list or table of objects. In response to receiving the object pair, the embeddings relationship system 202 provides the objects to the object pair analogy model 300, which includes providing them to a machine-learning model as input.

In various implementations, the embeddings relationship system 202 provides the input object pair as one action or two actions. For example, depending on how the machine-learning model is designed (e.g., because the model is designed for a different type of input data), the model may only accept a single input. In these instances, the embeddings relationship system 202 provides the input objects serially (e.g., one at a time). In other instances, if the machine-learning model accepts multiple inputs, the embeddings relationship system 202 provides input objects in parallel for inferencing.

As shown, the object pair analogy model 300 includes an act 304 of generating encoded input points in the embedding space of the machine-learning model for the objects in the input object pair. For example, the embeddings relationship system 202 utilizes the machine-learning model to begin processing the input object pair to generate encoded input points for each object in the embedding space of the machine-learning model. In other words, the embeddings relationship system 202 utilizes the machine-learning model, which has been trained to generate embeddings or encoded points from inputs, to encode each input object in the input object pair. In some implementations, the encoded input points of the input object pair are included alongside encoded points generated from training data or other input data previously provided to the machine-learning model.

Additionally, the object pair analogy model 300 includes an act 306 of determining a pairwise embedding relationship between the pair of encoded input points within the embedding space. For example, the embeddings relationship system 202 determines how the pair of encoded input points relate to each other within the embedding space. In one or more implementations, the embeddings relationship system 202 utilizes the object pair analogy model 300 to determine one or more relationships (e.g., embeddings semantic relationship) between the pair of encoded input points by identifying, analyzing, measuring, and/or evaluating the encoded input points.

To illustrate, the embeddings relationship system 202 determines a pairwise embedding relationship between the encoded input point pair based on a distance, angle, path relationship, relative position, location, and/or other measurements between the encoded input point pair. For example, the embeddings relationship system 202 determines the pairwise embedding relationship as a featurized relationship based on measuring the distance (e.g., Euclidean or other) and/or angle (e.g., cosine or other) between the two encoded input points within the embedding space. In some implementations, the embeddings relationship system 202 utilizes a function of distance subject to or constrained by an angle, or vice versa. Indeed, the computing device 200 can determine one or more pairwise embedding relationships between the encoded input point pair.

As shown, the object pair analogy model 300 includes an act 308 of determining other pairs of encoded points in the embedding space that share the pairwise relationship. For example, the embeddings relationship system 202 identifies other encoded points within the embedding space of the machine-learning model. The embeddings relationship system 202 then forms embedding pairs between these other encoded points and determines pairwise embedding relationships for these newly identified other pairs of embedding points.

When searching for other encoded points, in various instances, the embeddings relationship system 202 can optionally limit the search space to a fixed-size neighborhood around all inputs. For example, the embeddings relationship system 202 limits neighborhood size in terms of 1) an absolute distance in embedding space, 2) a proportion of a total embedding space size, 3) the number of nearest neighbors (either in terms of distance or the number of hops in the kNN graph approximating the data manifold), and/or 4) a partition of the embedding space. In one or more implementations, the computing device 200 sets distance computations to match the distance measure used by the model in training (e.g., cosine-distance, L2 distance).

Further, the embeddings relationship system 202 compares the pairwise embedding relationship for the encoded input point pair of the input objects to the other embedding pairs in the embedding space. For example, the embeddings relationship system 202 determines which of the other encoded point pairs have a similar pairwise embedding relationship to the encoded input point pair. In some implementations, the embeddings relationship system 202 determines the similar pairwise embedding relationships based on a threshold being satisfied. For instance, if the pairwise embedding relationship is based on distance, pairs of other encoded points are deemed similar to the pair of encoded input points when their distance measurement is within a threshold distance of the distance measurement of the encoded point input pair.

As shown in FIG. 3, the act 308 includes a full-scale approach 308a and an approximation approach 308b. In various implementations, the full-scale approach 308a corresponds to checking all (or the majority) possible pairwise embedding relationships between all (or most) encoded points within the embedding space. This full-scale approach 308a becomes more resource intensive as the number of encoded points increases.

In some implementations, the embeddings relationship system 202 utilizes the approximation approach 308b, which corresponds to generating local embedding point pairs for encoded points around the encoded input points as well as non-local and/or randomized point pairs. To further illustrate, suppose the encoded input points from the input object pair are represented as points (x, y). For each encoded point, the embeddings relationship system 202 identifies neighbor points and forms local pair point combinations (e.g., other encoded point pairs). Further, the embeddings relationship system 202 can featurize the relationships of the combinations, as provided above. Additionally, the embeddings relationship system 202 also forms non-local, random, or remote pair point combinations from the other encoded point pairs by sampling random points (e.g., (x, z) or (x, y) where z is a random encoded point) and featurizing these point pair combinations. Then, in various instances, the embeddings relationship system 202 saves each point pair (e.g., local and non-local) that shares the pairwise embedding relationship with the encoded input point pair.

In some implementations, the embeddings relationship system 202 also compares the local pairwise embedding relationships to the non-local pairwise embedding relationships to determine whether there exists a discernable difference between (x, y) and (x, z), where z is random. In various implementations, the embeddings relationship system 202 verifies the local encoded point pairs compared to a random sampling of encoded point pairs. In this manner, the embeddings relationship system 202 verifies that the approximation accurately identifies encoded point pairs in the embedding space that share a given relationship with that of the encoded input point pair.

As shown, the object pair analogy model 300 includes an act 310 of generating a set of output object pairs from the other pairs of encoded points. For example, for the set of other encoded point pairs that are determined to have a similar pairwise embedding relationship, the embeddings relationship system 202 maps the encoded points to their corresponding objects. Additionally, the embeddings relationship system 202 generates a set of output object pairs from the set of other encoded point pairs by pairing objects that have paired embedding points. In this manner, the embeddings relationship system 202 generates pairs of output objects in a set that share a relationship type with the input object pair.

As mentioned, in various implementations, the embeddings relationship system 202 ranks the results by similarity. In one or more implementations, the embeddings relationship system 202 sets and utilizes a threshold of closeness to include and/or exclude matches. In some instances, the threshold of closeness is determined by an Lp-distance measure, by an angle (e.g., for models using cosine distance), by the number of hops in the kNN graph, or any combination of the above.

Additionally, as shown, the object pair analogy model 300 includes an optional act 312 of ranking the output object pairs based on one or more relationship metrics. For example, in various implementations, the embeddings relationship system 202 determines which of the output object pairs is closest to the pairwise embedding relationship of the encoded input points of the input objects. In some examples, the embeddings relationship system 202 randomly or statistically samples output object pairs to include as the provided output. As another example, the embeddings relationship system 202 applies one or more relationship metrics to rank the output object pairs. The embeddings relationship system 202 can utilize the ranking to sort the output object pairs.

Lastly, the object pair analogy model 300 includes an act 314 of determining a relationship type in the embedding space based on providing the set of output object pairs. For example, the embeddings relationship system 202 provides the output object pairs along with a signal indicating whether a given relationship between the input object pair is present in the output object pairs. In some implementations, the embeddings relationship system 202 provides the output object pairs to a client device where a user is able to infer or determine whether the machine-learning model preserves a given relationship between the input object pair and the output object pairs.

In some implementations, the object pair analogy model 300 produces a single output object set, where each object pair shares the same relationship type as one another. In other implementations, the object pair analogy model 300 may produce multiple output object pairs (from the same input object pair), where the different output object sets correspond to different types of relationships preserved in the embedding space of the machine-learning model. For example, Output Object Set 1 corresponds to Relationship Type 1 and Output Object Set 2 corresponds to Relationship Type 2, where the input object set includes both Relationship Types 1 and 2. The embeddings relationship system 202 may produce the multiple output object pair sets in one iteration or separate iterations.

In greater detail, the following provides two example algorithms that the embeddings relationship system 202 implements as part of the object pair analogy model 300. Both algorithms include preprocessing steps and query steps. In both algorithms, the embeddings relationship system 202 generates the output object pairs.

As shown below, Algorithm 1 corresponds to the full-scale approach 308a (e.g., a brute force approach) mentioned above.

Algorithm 1

Preprocessing
1. With a full set of points, compute all possible pairs (p_1, p_2, . . .,
p_{n choose 2}), where each pair is p_i = (x, y), for points x and y.
2. For any pair, featurize relationship R as distance and angle:

| | |
|---|---|
| Scaled Distance: | 1 − eucl_dist(x, y) / max_dist |
| Cosine Similarity: | dot(x, y) / ∥x∥•∥y∥ |
| Featurized Relationship R: | R(p_i) = (dist, cosine_similarity) |

```
Query
3. Given a query pair p_i, build rankings over (R_1, R_2, . . ., R_{n choose 2}),
using 1) distance and 2) cosine similarity.
  For final results, in some cases, combine rankings (e.g., sort in ascending
  order by [rank(dist) + rank(cosine_similarity)]).
```

As shown below, Algorithm 2 corresponds to the approximation approach 308b.

Algorithm 2

```
Preprocessing
1 Let eps be a closeness threshold such that values below eps indicate an
acceptable match.
2. Let K be the number of local neighbors to search.
3. Let M be the number of random non-local neighbors to inspect.
Query
4. Query with a pair of points (x, y).
5. Search locally:
  Collect a set of K neighbors for each of x and y, as N(x) and N(y).
  Featurize relationship R (see algorithm 1) for all K² combinations between a
  member of N(x) and a member of N(y) -- or sample.
  Keep relationships that satisfy threshold eps.
6. Search non-locally:
  M times:
    Sample a random point z.
    Add an angle direction of the query, yielding z′ = z + angle_vector.
    Collect neighbors of z′ as N(z′)(e.g., within a given closeness threshold).
    Featurize relationship R for all combinations of z and N(z′).
    Keep relationships that satisfy threshold eps.
7. Collect relationships that satisfy eps, map back to points, and show ranked
results.
```

Turning to the next figure, FIG. 4 shows an example operational diagram of an object similarity embeddings relationship query model 400 (or “object similarity model 400” for short) in accordance with one or more implementations. As shown, FIG. 4 includes various acts corresponding to the object similarity model 400 for determining relationship types generally encoded in the embedding space of a machine-learning model. For example, the object similarity model 400 may be particularly helpful in uncovering what a machine-learning model has learned and what features it encodes from given inputs.

To elaborate, in some similarity search applications, a system returns several objects similar to a given object. Additionally, when input objects are complex, the results do not provide a clear indication regarding what type of similarity is captured by the machine-learning model. However, the embeddings relationship system 202 is able to utilize the object similarity model 400 to generate one or more output object pairs that share given relationships. Further, as provided below, in many implementations, the embeddings relationship system 202 feeds the output of the object similarity model 400 as input into the object pair analogy model 300 to generate further pairs each having the same relationship as the input, which better indicates which relationships are being valued within the embedding space of the model.

As shown in FIG. 4, the object similarity model 400 includes an act 402 of providing a machine-learning model with an input object. As mentioned above, in some implementations, the computing device 200 provides an input object pair to the machine-learning model. In alternative implementations, the embeddings relationship system 202 provides a single input object. As mentioned above, the input object can be from an arbitrary source not related to training, testing, or running the machine-learning model.

In addition, the object similarity model 400 includes an act 404 of generating an encoded input point in the embedding space of the machine-learning model for the input object. For example, the embeddings relationship system 202 feeds the input object through the machine-learning model to cause the model to generate an embedding or encoded input point for the input object within the embedding space of the model.

Upon generating the encoded point for the input object in the embedding space, the encoded point will be surrounded by other encoded points from previous input data processed by the model. Accordingly, as shown, the object similarity model 400 includes an act 406 of identifying an encoded point with the embedding space that is within a predefined distance metric (e.g., adjacent) of the encoded input point. For example, in various implementations, the embeddings relationship system 202 identifies one or more other encoded points that are near (e.g., within the predefined distance metric) the encoded input point in the embedding space. Further, in additional implementations, the embeddings relationship system 202 determines which of the other encoded points is the closest and/or most similar to the encoded input point.

As provided above, the embeddings relationship system 202 may utilize one or more measuring approaches to determine which of the other encoded points best matches the encoded input point. In many implementations, the closest or most similar encoded point will have one or more embedding relationships with the encoded input point. Indeed, the embeddings relationship system 202 utilizes the object similarity model 400 to determine which relationship types the machine-learning model has been taught to value most. In some implementations, the embeddings relationship system 202 applies diversity measures to ensure the other encoded points are sufficiently different from each other while still being similar to the encoded input point according to a predefined distance metric.

As shown, the object similarity model 400 includes an act 408 of generating an object pair from the input object and the object that corresponds to the identified encoding point. For instance, in various implementations, the embeddings relationship system 202 identifies the object that corresponds to the identified encoded point and joins the identified object to the single input object to generate an object pair.

Additionally, as shown, the object similarity model 400 includes an act 410 of determining a relationship in the embedding space based on providing the object pair. For example, as described above, in some instances, the embeddings relationship system 202 signals a relationship type based on one or more outputted object pairs. In some instances, upon the embeddings relationship system 202 providing the object pair to a client device, a user determines or infers a relationship about the output object pair as well as about what relationship types are being encoded on the embedding space on the model.

In some instances, the object similarity model 400 includes an optional act 412 of utilizing the object pair analogy model 300 to determine a relationship type in the embedding space from the output object pair. For example, the embeddings relationship system 202 utilizes the output object pair as input to the object pair analogy model 300 to generate additional similar output object pairs, which process is outlined above with respect to FIG. 3. Indeed, in one or more implementations, the object similarity model 400 forms the initial steps for the object pair analogy model 300.

Turning to the next figure, FIG. 5 shows an example operational diagram of an embeddings relationship preservation query model 500 (or “relationship preservation model 500” for short) in accordance with one or more implementations. As shown, FIG. 5 includes various acts corresponding to the relationship preservation model 500 for determining which relationships are preserved in the embedding space of a machine-learning model. For example, the relationship preservation model 500 may be particularly helpful in uncovering how relationship types within the embedding space of a machine-learning model change as the model is tuned, updated, and/or modified.

As an overview, the embeddings relationship system 202 characterizes a relationship type by a set of anchor pairs that all exhibit the same semantic relationship. These anchor pairs are characterized using their relative positions, distances, and angles in the embedding space of the machine-learning model, as computed by the embeddings relationship system 202. Then, the embeddings relationship system 202 performs similar computations for the random pairs. In various implementations, the embeddings relationship system 202 determines whether a relationship is present if the “anchor” results are distinguishable from the “random” results via permutation test, as provided below.

To elaborate, in various instances, the relationship preservation model 500 provides a tool for assessing if a given relationship is preserved within a machine-learning model. In particular, the relationship preservation model 500 is useful in determining whether a given relationship type across a set of input object pairs can be found in the embedding space of the model. Further, the relationship preservation model 500 provides a tool for determining if a relationship that was preserved in a previous version of a model is still preserved in an updated version of the model. Indeed, in many instances, the relationship preservation model 500 provides a relationship strength metric (e.g., a probability, percentile, or confidence value) for measuring if a given relationship type is significant for a model and if the significance value changed upon modifying the model.

To further elaborate, in several instances, the relationship preservation model 500 measures how strongly a relationship exhibited in a set of “anchor” object pairs is encoded in the embedding space. In one or more implementations, the embeddings relationship system 202 measures this strength of relationship as the degree to which relative positions of anchor pairs differ from the relative positions of random, non-anchored pairs, as described below.

To illustrate, in many implementations, the relationship preservation model 500 utilizes anchor object pairs to measure the significance of a given relationship type in a machine-learning model. As shown, the relationship preservation model 500 includes an act 502 of generating a set of anchor object pairs where each pair shares the same object relationship. For instance, the anchor object pairs include a set of State-Capital City pairs (e.g., Georgia-Atlanta, Hawaii-Honolulu, Texas-Austin, Nebraska-Lincoln, Virginia-Richmond, etc.).

In addition, the relationship preservation model 500 includes an act 504 of generating pairs of encoded anchor points in the embedding space of the machine-learning model for the set of anchor object pairs. For example, the embeddings relationship system 202 generates pairwise embeddings for each anchor object pair in the embedding space of the machine-learning model, as previously described.

Further, the relationship preservation model 500 includes an act 506 of generating an anchor object relationship metric based on determining the pairwise embedding relationship between the pairs of encoded anchor points. In one or more implementations, the embeddings relationship system 202 determines pairwise embedding relationships between each of the encoded anchor point pairs, as described above. For example, the embeddings relationship system 202 utilizes distance, angles, relative positions, or path relationships to determine the pairwise embedding relationships.

Further, in various implementations, the embeddings relationship system 202 combines features of the pairwise embedding relationships to generate an anchor object relationship metric, which represents the aggregate relationship strength across the set of pairwise embedding relationships corresponding to the anchor object pairs. For instance, the embeddings relationship system 202 generates the average relationship strength across the features of the pairwise embedding relationships of the anchor object pairs to determine the anchor object relationship metric. In some instances, the embeddings relationship system 202 utilizes another approach to generate the anchor object relationship metric.

As shown in FIG. 5, the relationship preservation model 500 also includes an act 508 of generating a set of non-anchor object pairs by randomly replacing one of the paired objects in each anchor object pair. In one or more implementations, the embeddings relationship system 202 replaces one of the objects in one or more of the anchor object pairs with a randomly selected object (e.g., from a set of available objects) to generate a set of non-anchor object pairs. Indeed, in these implementations, the embeddings relationship system 202 randomly changes half of each anchor object pair to create the set of non-anchor object pairs. For instance, the non-anchor object pairs include a set of State-Capital City pairs with cities not necessarily corresponding to states or not being capitals (e.g., Georgia-Savannah, Hawaii-Hilo, Texas-Paris, Nebraska-San Jose, and/or Virginia-New York City, etc.).

Additionally, as shown, the relationship preservation model 500 includes an act 510 of generating pairs of encoded non-anchor points in the embedding space of the machine-learning model for this set of non-anchor object pairs. For example, the embeddings relationship system 202 repeats the act 504 for the non-anchor object pairs. In some implementations, the embeddings relationship system 202 performs the act 510 by skipping the act 508, described above, and generates random pairs directly in the embedding space. In these implementations, the act 510 may draw knowledge from the generated pairs of encoded anchor points described above in the act 504.

Similarly, the relationship preservation model 500 includes an act 512 of generating a non-anchor object relationship metric based on determining the pairwise embedding relationship between the pairs of encoded non-anchor points. Again, in many instances, the embeddings relationship system 202 repeats the act 506 for the pairwise embedding relationships for the non-anchor points to generate a non-anchor object relationship metric.

As shown, the relationship preservation model 500 includes an act 514 of generating a given object relationship metric based on comparing the anchor object relationship metric to the non-anchor object relationship metric. In various implementations, the given object relationship metric is expressed as a probability, percentile, or confidence value. For example, the embeddings relationship system 202 utilizes the relationship preservation model 500 to determine a confidence value for the model preserving the State-Capital City relationship.

In one or more implementations, the embeddings relationship system 202 determines the object relationship metric for the given relationship type expressed in the anchor object pairs using a rule-based heuristic model. In some implementations, the embeddings relationship system 202 utilizes machine learning to determine the given object relationship metric. For example, the embeddings relationship system 202 utilizes the anchor object relationship metric and the non-anchor object relationship metric to generate a classifier or sub-model. The embeddings relationship system 202 then trains the classifier to detect anchor object pairs as “positive” and non-anchor pairs as “negative.” In these instances, the embeddings relationship system 202 utilizes the performance of the classifier as the given object relationship metric (e.g., determine that the machine-learning model preserves a given object relationship based on the performance of the classifier). Additional details regarding utilizing a classifier are provided below in Algorithm 3.

The relationship preservation model 500 also includes an act 516 of determining that the machine learning model preserves the given object relationship based on the given relationship strength metric satisfying a relationship strength metric. For instance, if the given object relationship metric (e.g., a probability, percentile, or confidence value) satisfies a corresponding relationship strength metric (e.g., meets or exceeds), the embeddings relationship system 202 determines that the relationship type in the anchor object pairs is preserved in the embedding space. Indeed, this indicates that the anchor object pairs have significantly stronger pairwise embedding relationships than those of the non-anchor pairs. Otherwise, if the given object relationship metric does not satisfy the relationship strength metric, the embeddings relationship system 202 determines that the relationship type in the anchor object pairs is not preserved in the model.

As shown, FIG. 5 includes two optional acts. These are shown below the dashed line 518, which represents the passage of time. As mentioned above, these additional acts demonstrate how the embeddings relationship system 202 tracks changes in relationship type across a changing machine-learning model.

To illustrate, the relationship preservation model 500 includes a first optional act 520 of generating a modified given object relationship metric based on determining that the machine-learning model has been modified. For instance, the embeddings relationship system 202 determines that the machine-learning model has been updated, tuned, further trained, and/or otherwise modified. In response, the embeddings relationship system 202 determines a modified given object relationship metric utilizing the acts and approaches provided above. For example, the embeddings relationship system 202 repeats the acts 502-514 with the updated machine-learning model.

In addition, the relationship preservation model 500 includes a second optional act 522 of determining that the machine-learning model preserves the given object relationship based on the modified given object relationship metrics satisfying the relationship strength metric. For example, the embeddings relationship system 202 repeats the act 516 with the modified given object relationship metric. If the modified given object relationship metric satisfies the relationship strength metric, then the modified machine-learning model still preserves the relationship type of the anchor object pairs in the embedding space.

In some implementations, the embeddings relationship system 202 determines if the given object relationship metric increases or decreases in relationship strength. For example, the embeddings relationship system 202 compares the given object relationship metric to the modified given object relationship metric to determine whether the object relationship metric increased in strength, or vice versa.

In greater detail, the following provides an example algorithm, Algorithm 3, that the embeddings relationship system 202 implements as part of the relationship preservation model 500.

Algorithm 3

```
1. Collect or generate anchor object pairs.
2. Collect or generate random object pairs.
  For each anchor object pair with a “head” and a “tail”:
    Generate random object pairs by iteratively fixing the “head” and
    sampling a new tail or by fixing the “tail” and sampling a new head.
  Collect the random object pairs into a single list.
3. Determine statistics about anchor object pairs.
4. Determine statistics about random object pairs.
5. Create a classifier and train it to detect anchor object pairs as “positive” and
random object pairs as “negative.”
6. Collect and report the performance of the classifier.
  Interpret strong classifier performance as a signal of a relationship in the
  data. Strong classifier performance signals a relationship that is classified
  with statistical significance.
```

Turning to the next figure, FIG. 6 shows an example operational diagram of an emergent semantics embeddings relationship query model 600 (“emergent semantics model 600” for short) in accordance with one or more implementations. As shown, FIG. 6 includes various acts corresponding to the emergent semantics model 600 for determining emergent semantics in the embedding space of a machine-learning model.

As noted in this document, it is helpful to discover what relationships are being formed within a machine-learning model. Accordingly, the emergent semantics model 600 provides a tool for discovering emergent semantics within a given machine-learning model. To elaborate, given only an embedding space, the embeddings relationship system 202 searches pairwise embedding relationships to identify emergent semantics. The embeddings relationship system 202 returns the emergent semantics in the form of object pairs representing common relationships expressed in the embedding space. In some instances, the output pairs correspond to the strongest relationships encoded by the model, provided in the form of example object pairs that form explicit analogies, which are intelligible to users.

By utilizing the emergent semantics model 600, the embeddings relationship system 202 provides an explain-by-example tool to describe what relationships are being formed by the model. Additionally, the emergent semantics model 600 does not require any manual description, as is needed when labeling clusters from a clustering algorithm. Further, by utilizing the emergent semantics model 600, the embeddings relationship system 202 avoids the intricate experimentation structure of perturbation and sensitivity analysis. Rather, the embeddings relationship system 202 works strictly in the embedding space, making it modality-agnostic, and low-burden to users.

As mentioned above, the emergent semantics model 600 operates without providing any input to a machine-learning model. Rather, the emergent semantics model 600 explores the embedding space of the model to determine if there are clusters of commonly related embeddings. In some instances, the emergent semantics model 600 identifies a relationship space based on large clusters of related encoded points (with a minimum density) and/or high-density regions (with a minimum number of encoded points). Then, for the embeddings in these groups, the emergent semantics model 600 provides tools to identify and communicate the strongest relationships that are encoded by the model. As indicated above, this process is sometimes called explain-by-example.

To further illustrate, FIG. 6 shows that the emergent semantics model 600 includes an act 602 of identifying pairs of encoded points in the embedding space of a machine learning model. In one or more implementations, the embeddings relationship system 202 accesses the embedding space of a machine learning model and begins to identify encoded points. Further, in various instances, the embeddings relationship system 202 generates pairs between the encoded points.

In various implementations, the embeddings relationship system 202 generates encoded point pairs based on points in the embedding space. In some implementations, the embeddings relationship system 202 takes a large random sub-sample of points. In one or more implementations, the embeddings relationship system 202 takes a strategic sub-sample of encoded point pairs (e.g., avoiding oversampling individual clusters).

As shown, the emergent semantics model 600 includes an act 604 of generating pairwise relationship features for each encoded point pair in the embedding space. For example, the embeddings relationship system 202 determines features of pairwise relationships based on distance, angle, path relationship, and/or relative position. Indeed, the embeddings relationship system 202 identifies one or more relationships among the encoded point pairs within the embedding space of the model.

As also shown, the emergent semantics model 600 includes an act 606 of clustering a group of embedded point pairs having pairwise relationship features within a cluster threshold. In various implementations, the embeddings relationship system 202 generates clusters for each of the identified relationships. For instance, the embeddings relationship system 202 generates a first cluster for a first set of features of encoded point pairs that exhibit a first relationship type and a second cluster for a second set of features of encoded point pairs that share a second relationship type.

The embeddings relationship system 202 can utilize various approaches to form clusters. To illustrate, FIG. 6 includes a cluster distance threshold 606a, a cluster density threshold 606b, and/or other cluster thresholds. For example, the embeddings relationship system 202 generates a cluster of encoded point pairs based on a cluster distance threshold 606a. In this manner, the embeddings relationship system 202 identifies features encoded point pairs having prevalent relationships.

To elaborate, in various implementations, the cluster distance threshold 606a corresponds to generating a cluster for features of encoded point pairs that are within a given distance of each other in the embedding space. In some implementations, the cluster distance threshold 606a corresponds to features of the pairwise embedding relationship of encoded point pairs being within a given distance. In either case, or in other cases that utilize the cluster distance threshold 606a, the embeddings relationship system 202 groups encoded point pairs into a cluster when for features the encoded point pairs satisfy the cluster distance threshold 606a. In various implementations, the embeddings relationship system 202 requires one of these clusters to also satisfy a minimum density threshold (e.g., a version of the cluster density threshold 606b).

In one or more implementations, the embeddings relationship system 202 groups encoded point pairs into a cluster when the features of the encoded point pairs satisfy the cluster density threshold 606b. For example, the embeddings relationship system 202 forms a cluster with encoded point pairs that reside in a high-density region of the embedding space. In some instances, the embeddings relationship system 202 also requires that these clusters also have a minimum number of encoded point pairs. In this manner, the embeddings relationship system 202 identifies encoded point pairs that are most similar in nature to each other.

In various implementations, the embeddings relationship system 202 groups encoded point pairs into a cluster when encoded point pairs satisfies one or more other cluster thresholds. For example, the embeddings relationship system 202 utilizes kNN clustering on the encoded point pairs to generate clusters.

As shown, the emergent semantics model 600 includes an optional act 608 of filtering the encoded point pairs based on one or more feature characteristics. In various implementations, the embeddings relationship system 202 filters one or more of the clusters based on encoded point characteristics. For example, in various instances, the emergent semantics model 600 provides tools to filter results based on one or more characteristics. For instance, the emergent semantics model 600 may cause the machine-learning model to yield several relationships having different levels of relationship strengths. Accordingly, in some implementations, the emergent semantics model 600 allows for filtering the results to identify a more targeted result (e.g., only include object pairs that include cities).

FIG. 6 also shows that the emergent semantics model 600 includes an act 610 of generating a set of output object pairs from the encoded point pairs. As mentioned above, the embeddings relationship system 202 identifies objects that correspond to identified encoded points. The embeddings relationship system 202 then generates a set of output object pairs by generating object pairs that correspond to the identified encoded point pairs.

Additionally, the emergent semantics model 600 includes an act 612 of determining one or more relationship types in the embedding space based on providing the set of output object pairs. For example, the embeddings relationship system 202 provides the output object pairs to reveal the emergent semantics of importance within the embedding space of the model. In some implementations, the embeddings relationship system 202 provides the output object pairs to a client device where a user is able to infer or determine one or more of the emergent semantics of the machine-learning model.

In many instances, the embeddings relationship system 202 provides one or more sets of output object pairs that reveal relationships encoded within the embedding space of the model. In some instances, however, the embeddings relationship system 202 provides an output object pair that does not have a discernable relationship. In these instances, the output object pair may reveal problems or issues with the model (e.g., the model has been improperly trained to focus on the wrong relationships).

In greater detail, the following provides an example algorithm, Algorithm 4, that the embeddings relationship system 202 implements as part of the emergent semantics model 600.

Algorithm 4

```
1. Generate a set of point pairs:
  Option 1: All pairs
  Option 2: Large random sub-sample
  Option 3: Strategic subsample (e.g., avoiding oversampling individual
  clusters).
2. Compute features of pairwise relationships (e.g., based on distance, angle, or
path relationship).
3. Cluster features.
4. Report statistics in a new “relationship space”.
  a. Largest cluster of relationships (that also satisfies a minimum density).
    This represents a predominant or popular relationship.
  b. Highest-density region (that also satisfies a minimum number of points).
    This represents a subset of pairs that have extremely similar
    relationships.
5. Optionally, filter results based on point characteristics.
```

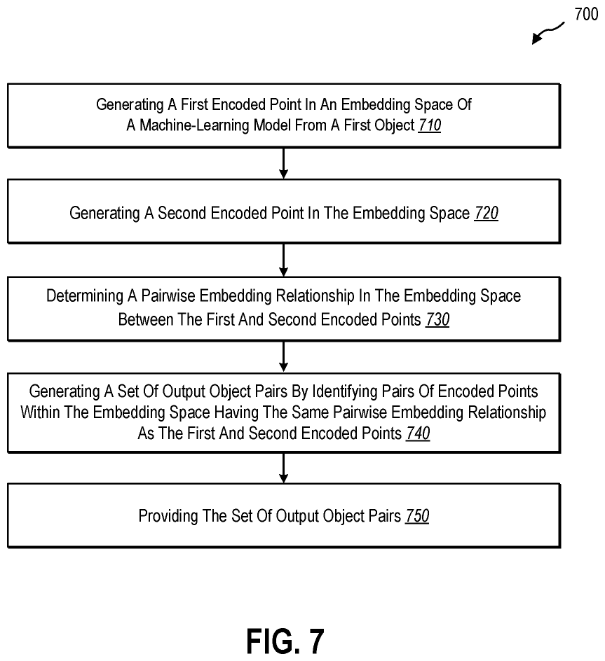

Turning now to FIG. 7, this figure illustrates example flowcharts that include a series of acts for utilizing the embeddings relationship system 202 in accordance with one or more implementations. While FIG. 7 illustrates acts according to one or more implementations, alternative implementations may omit, add to, reorder, and/or modify any of the acts shown. Further, the acts of FIG. 7 can be performed as part of a method. Alternatively, a non-transitory computer-readable medium can include instructions that, when executed by at least one processor, cause a computing device to perform the acts of FIG. 7. In still further implementations, a system can perform the acts of FIG. 7.

To illustrate, FIG. 7 shows an example series of acts for utilizing a machine-learning model to determine the relationship of embeddings for the machine-learning model in accordance with one or more implementations. As shown, the series of acts 700 includes an act 710 of generating a first encoded point in an embedding space of a machine-learning model from a first object. For instance, the act 710 may involve generating a first encoded point in an embedding space by encoding a first object utilizing a machine-learning model where the embedding space includes encoded points based on a set of input data.

As further shown, the series of acts 700 includes an act 720 of generating a second encoded point in the embedding space. For example, the act 720 may involve generating a second encoded point in the embedding space by encoding a second object utilizing the machine-learning model.

As further shown, the series of acts 700 includes an act 730 of determining a pairwise embedding relationship in the embedding space between the first and second encoded points. For example, the act 730 may involve determining, within the embedding space, a pairwise embedding relationship between the first encoded point and the second encoded point.

As further shown, the series of acts 700 includes an act 740 of generating a set of output object pairs by identifying pairs of encoded points within the embedding space having the same pairwise embedding relationship as the first and second encoded points. For example, the act 740 may involve generating a set of output object pairs by identifying pairs of objects that correspond to pairs of encoded points within the embedding space having the pairwise embedding relationship. In various implementations, the act 740 includes ranking the pairs of objects within the set of output object pairs based on a relationship strength metric and/or determining the relationship strength metric for an object pair in the set of output object pairs based on a combination of vector distance and vector angle.

As further shown, the series of acts 700 includes an act 750 of providing the set of output object pairs. For example, the act 750 may involve providing the set of output object pairs to a client device and/or another computing device.

Additionally, the series of acts 700 may include various additional acts. To illustrate, in one or more implementations, the series of acts 700 includes acts of determining a first input object relationship between the first object and the second object and determining that the embedding space of the machine-learning model preserves the first input object relationship by identifying the first input object relationship between each of the pairs of objects in the set of output object pairs. In various implementations, the series of acts 700 includes acts of determining, within the embedding space, an additional pairwise embedding relationship between the first encoded point and the second encoded point, where the additional pairwise embedding relationship differs from the pairwise embedding relationship; identifying additional pairs of encoded points within the embedding space that have the additional pairwise embedding relationship based on satisfying a threshold; generating an additional set of output object pairs that includes an additional pairs of objects that correspond to the additional pairs of encoded points within the embedding space; determining a second input object relationship between the first object and the second object; and/or determining that the embedding space of the machine-learning model preserves the second input object relationship by identifying the second input object relationship between each of the additional pairs of objects in the additional set of output object pairs.

In one or more implementations, the series of acts 700 includes acts of generating pairwise relationship features for each point pair in a set of point pairs in the embedding space; clustering a group of point pairs having pairwise relationship features within a cluster distance threshold or a cluster density threshold; and providing object pairs corresponding to the group of point pairs as the set of output object pairs.

In some implementations, the series of acts 700 includes acts of providing the first object to the machine-learning model to generate the first encoded point; identifying an encoded point within the embedding space that is close to the first encoded point according to a predefined distance metric; determining that the encoded point corresponds to a second object; generating an object pair that includes the first object and the second object; and utilizing the object pair as object inputs to the machine-learning model before generating the pairwise embedding relationship for the first encoded point and/or the second encoded point. In various implementations, the series of acts 700 also includes an act of determining one or more relationship types preserved in the embedding space from the set of input data based on analyzing the set of output object pairs.

In some implementations, the series of acts 700 includes acts of obtaining, identifying, or generating a set of anchor object pairs that shares a given object relationship between paired objects within each anchor object pair, where the set of anchor object pairs includes the first object in an anchor pair with the second object; generating pairs of encoded anchor points from the set of anchor object pairs utilizing the machine-learning model; generating an anchor embedding relationship metric based on determining the pairwise embedding relationship between the pairs of encoded anchor points; generating a set of non-anchor object pairs by randomly replacing one of the paired objects in each anchor object pair within the set of anchor object pairs; generating pairs of encoded non-anchor points from the set of non-anchor object pairs utilizing the machine-learning model; and/or generating a non-anchor embedding relationship metric based on determining an additional pairwise embedding relationship between the pairs of encoded non-anchor points.

In additional implementations, the series of acts 700 includes acts of generating a given object relationship metric based on comparing the anchor embedding relationship metric to the non-anchor embedding relationship metric; and determining that the machine-learning model preserves the given object relationship based on the given object relationship metric satisfying a relationship strength metric. In some implementations, the series of acts 700 also includes acts of determining whether or that the machine-learning model has been modified; generating a modified given object relationship metric; and determining that the machine-learning model continues to preserve the given object relationship based on the modified given object relationship metric satisfying the relationship strength metric. In one or more implementations, the series of acts 700 includes acts of generating a classifier to detect the anchor object pairs as positive and the non-anchor object pairs as negative and determining that the machine-learning model preserves the given object relationship based on a performance of the classifier.

A “computer network” (hereinafter “network”) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry needed program code means in the form of computer-executable instructions or data structures and which can be accessed by a general-purpose or special-purpose computer. Combinations of the above should also be included within the scope of computer-readable media.

In addition, the network (i.e., computer network) described herein may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the embeddings relationship system 202. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network (i.e., computer network) or data link can be buffered in RAM within a network interface module (NIC), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include, for example, instructions and data that, when executed by at least one processor, cause a general-purpose computer, special-purpose computer, or special-purpose processing device to perform a certain function or group of functions. In some implementations, computer-executable instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

FIG. 8 illustrates certain components that may be included within a computer system 800. The computer system 800 may be used to implement the various computing devices, components, and systems described herein.

In various implementations, the computer system 800 may represent one or more of the client devices, server devices, or other computing devices described above. For example, the computer system 800 may refer to various types of network devices capable of accessing data on a network (i.e., a computer network), a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processor 801 (i.e., at least one processor). The processor 801 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 801 may be referred to as a central processing unit (CPU). Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network (i.e., computer network), both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium including instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can include at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is therefore indicated by the appended claims rather than by the foregoing description. Changes that come within the meaning and range of equivalency of the claims are to be embraced within their scope.

What is claimed is:

1. A computer-implemented method, comprising:
generating a first encoded point in an embedding space by encoding a first object utilizing a machine-learning model, wherein the embedding space includes encoded points based on a set of input data;
generating a second encoded point in the embedding space by encoding a second object utilizing the machine-learning model;
determining, within the embedding space, a pairwise embedding relationship between the first encoded point and the second encoded point;
generating a set of output object pairs by identifying pairs of objects that correspond to pairs of encoded points within the embedding space having the pairwise embedding relationship; and
providing the set of output object pairs to a client device.

2. The computer-implemented method of claim 1, further comprising:
determining a first input object relationship between the first object and the second object; and
determining that the embedding space of the machine-learning model preserves the first input object relationship by identifying the first input object relationship between each of the pairs of objects in the set of output object pairs.

3. The computer-implemented method of claim 1, further comprising:
providing the first object to the machine-learning model to generate the first encoded point;
identifying an encoded point within the embedding space that is close to the first encoded point according to a predefined distance metric;
determining that the encoded point corresponds to a second object;
generating an object pair that includes the first object and the second object; and
utilizing the object pair as object inputs to the machine-learning model before generating the pairwise embedding relationship between the first encoded point and the second encoded point.

4. The computer-implemented method of claim 3, further comprising determining one or more relationship types preserved in the embedding space from the set of input data based on analyzing the set of output object pairs.

5. The computer-implemented method of claim 1, further comprising:
generating pairwise relationship features for each point pair in a set of point pairs in the embedding space;
clustering a group of point pairs having pairwise relationship features within a cluster distance threshold or a cluster density threshold; and
providing object pairs corresponding to the group of point pairs as the set of output object pairs.

6. The computer-implemented method of claim 1, further comprising:
obtaining a set of anchor object pairs that shares a given object relationship between paired objects within each anchor object pair, wherein the set of anchor object pairs includes the first object in an anchor pair with the second object;
generating pairs of encoded anchor points from the set of anchor object pairs utilizing the machine-learning model; and
generating an anchor embedding relationship metric based on determining the pairwise embedding relationship between the pairs of encoded anchor points.

7. The computer-implemented method of claim 6, further comprising:
generating a set of non-anchor object pairs by randomly replacing one of the paired objects in each anchor object pair within the set of anchor object pairs;
generating pairs of encoded non-anchor points from the set of non-anchor object pairs utilizing the machine-learning model; and
generating a non-anchor embedding relationship metric based on determining an additional pairwise embedding relationship between the pairs of encoded non-anchor points.

8. The computer-implemented method of claim 7, further comprising:
generating a given object relationship metric based on comparing the anchor embedding relationship metric to the non-anchor embedding relationship metric; and
determining that the machine-learning model preserves the given object relationship based on the given object relationship metric satisfying a relationship strength metric.

9. The computer-implemented method of claim 7, further comprising:
generating a classifier to detect the anchor object pairs as positive and the non-anchor object pairs as negative; and
determining that the machine-learning model preserves the given object relationship based on a performance of the classifier.

10. The computer-implemented method of claim 8, further comprising:
determining that the machine-learning model has been modified;
generating a modified given object relationship metric; and
determining that the machine-learning model preserves the given object relationship based on the modified given object relationship metric satisfying the relationship strength metric.

11. A system comprising:
at least one processor at a server device; and
a computer memory comprising instructions that, when executed by the at least one processor at the server device, cause the system to carry out operations comprising:
generating a first encoded point in an embedding space by encoding a first object utilizing a machine-learning model, wherein the embedding space includes encoded points based on a set of input data;
generating a second encoded point in the embedding space by encoding a second object utilizing the machine-learning model;
determining, within the embedding space, a pairwise embedding relationship between the first encoded point and the second encoded point;
generating a set of output object pairs by identifying pairs of objects that correspond to pairs of encoded points within the embedding space having the pairwise embedding relationship; and
providing the set of output object pairs.

12. The system of claim 11, further comprising instructions that, when executed by the at least one processor, cause the system to carry out operations comprising:
determining a first input object relationship between the first object and the second object; and
determining that the embedding space of the machine-learning model preserves the first input object relationship by identifying the first input object relationship between each of the pairs of objects in the set of output object pairs.

13. The system of claim 12, further comprising instructions that, when executed by the at least one processor, cause the system to carry out operations comprising:
determining, within the embedding space, an additional pairwise embedding relationship between the first encoded point and the second encoded point, wherein the additional pairwise embedding relationship differs from the pairwise embedding relationship;
identifying additional pairs of encoded points within the embedding space that have the additional pairwise embedding relationship based on satisfying a threshold; and
generating an additional set of output object pairs that includes an additional pairs of objects that correspond to the additional pairs of encoded points within the embedding space.

14. The system of claim 13, further comprising instructions that, when executed by the at least one processor, cause the system to carry out operations comprising:
determining a second input object relationship between the first object and the second object; and
determining that the embedding space of the machine-learning model preserves the second input object relationship by identifying the second input object relationship between each of the additional pairs of objects in the additional set of output object pairs.

15. The system of claim 11, wherein generating the set of output object pairs includes ranking the pairs of objects within the set of output object pairs based on a relationship strength metric.

16. The system of claim 15, further comprising instructions that, when executed by the at least one processor, cause the system to carry out operations comprising determining the relationship strength metric for an object pair in the set of output object pairs based on a combination of vector distance and vector angle.

17. A computer-implemented method comprising:
generating a first encoded point in an embedding space by encoding a first object utilizing a machine-learning model, wherein the embedding space includes encoded points based on a set of input data;
determining, within the embedding space, a pairwise embedding relationship between the first encoded point and a second encoded point;
generating a set of output object pairs by identifying pairs of objects that correspond to pairs of encoded points within the embedding space having the pairwise embedding relationship; and
providing the set of output object pairs.

18. The computer-implemented method of claim 17, further comprising:
generating pairwise relationship features for each point pair in a set of point pairs in the embedding space;
clustering a group of point pairs having pairwise relationship features within a cluster distance threshold or a density threshold; and
providing object pairs corresponding to the group of point pairs.

19. The computer-implemented method of claim 17, further comprising:
determining a first input object relationship between the first object and a second object corresponding to the second encoded point; and
determining that the embedding space of the machine-learning model preserves the first input object relationship by identifying the first input object relationship between each of the pairs of objects in the set of output object pairs.

20. The computer-implemented method of claim 17, wherein generating the set of output object pairs includes ranking the pairs of objects within the set of output object pairs based on a relationship strength metric.
